(19) United States
(12) Patent Application Publication
(10) Pub. No.: US 2010/0174613 A1
(43) Pub. Date: Jul. 8, 2010

(54) Customer Sessions with Ticket Association using Lottery Point-of-Sale Devices

(76) Inventors: Thomas K. Oram, Hudson, MA (US); Stephen P. Lupo, Westerly, RI (US); Richard S. Meehan, South Kingston, RI (US)

Correspondence Address: Thomas F. Bergert;c/o WILLIAMS MULLEN IP docketing, 222 CENTRAL PARK AVENUE, SUITE 1700, VIRGINIA BEACH, VA, 23462, US

(21) Appl. No.: 12/649,122

(22) Filed: Dec. 29, 2009

Related U.S. Application Data
(60) Provisional application No. 61/207,866, filed on Dec. 29, 2008.

(51) Int. Cl. G06Q 50/00; A63F 9/24; G06Q 30/00; G06Q 20/00; G06F 3/12

(52) U.S. Cl. 705/17; 463/17; 358/1.15

(57) ABSTRACT

The present invention provides a system and method that facilitates the tracking of customer sessions for lottery customers using a lottery-related point-of-sale (POS) device and/or printer control device (PCD). Rather than printing and cutting receipts in that order, the present invention handles multiple gaming-related transactions by first issuing a cut command and then a print command as part of a command sequence for the second and subsequent transactions. When the customer has completed his or her gaming-related transactions, a final cut command is issued, followed by appropriate payment processing and customer session termination.

### REFERENCE TO RELATED APPLICATIONS

The present application claims the benefit of U.S. provisional application Ser. No. 61/207,866, filed Dec. 29, 2008, entitled “System, Device and Method for Paperless Wagering and Payment of Winnings,” which is incorporated by reference herein in its entirety.

### FIELD OF THE INVENTION

The present invention pertains to managing lottery customer sessions, and more particularly to systems and methods for printing lottery tickets and receipts so as to facilitate association of player accounts and transactions.

### BACKGROUND OF THE INVENTION

Unlike in most retail transactions, the concept of a customer session has never been strong in the lottery business. There is no proven way for a lottery provider to know how many or which type of transactions are performed within one customer session at a retailer. Although lottery point-of-sale (POS) terminals typically have a “total” key, the key is often not used and is primarily intended as an aid to the clerk. Further, because most lottery-related transactions are conducted with cash and are anonymous, there has been less of a need to establish accurate customer sessions. If customer sessions could be better identified, there would be better customer service, more accurate collection of customer relationship management (CRM) information and better accounting with transaction cards (e.g., debit cards, stored value cards, player cards and other transaction instruments).

According to typical lottery operations, the retailer clerk must hit the “Total-Send” key, or a similar key depending upon the POS terminal employed, to clear any references to the currently identified customer (i.e., player). The customer can be identified through a card having readable indicia such as a barcode thereon, where the indicia is read by an integrated reader on the terminal before or during the player's interaction at the POS. As the player is making wagers, wager information (or validation receipt information) is sent to a printer from the POS and typically followed by a “cut” command (or similar command, again depending upon the terminal). If the clerk does not hit the cut or “Total-Send” key between customers, there is a risk that tickets sold to the next customer will be recorded on the previous customer's account. Since the player's card can include automatic prize notification and may enable various prize options (such as transferring prize winnings, associating winnings with bonus games, etc.), it is important to properly track and associate players with their transactions. Many problems can result from improper customer session management.

### SUMMARY OF THE INVENTION

The present invention provides a system and method that facilitates the tracking of customer sessions for lottery customers using a lottery-related POS device or other type of printer control device (PCD). According to one aspect of the present invention, the PCD sends a command sequence to the printer depending upon the transaction involved. For example, when a wager is placed, the PCD instructs the printer to print the wager but, contrary to typical operations, does not send the cut command. Then, if another wager is placed, the PCD first sends a cut command (for the first wager), and then a command to print the next wager. After the subsequent print command is sent, there is again no cut command. A sequence of commands for subsequent wagers is issued such that the cut command is issued first, followed by a print command for each wager (or validation receipt) printed. When the customer has completed his or her wagers, there will be one ticket printed but not cut. The final cut will occur when the clerk hits the “total” or similar input key, thereby terminating the customer session.

The duration of the customer session can be from the initial identification of a new customer to the receipt by the PCD of an input denoting the last transaction has occurred. The last transaction can be the final wager or can be a payment processing transaction after all wagers and/or other transactions have been executed. Appropriate hardware, software and programming for carrying out computer instructions between the PCD and the printer for the present invention are provided.

If a player card, debit card or other type of transaction instrument tied to a player account is presented at any time during the customer session, the system of the present invention will know what wagers were included in that session. Thus, the present invention permits a player to associate purchased lottery game wagers (e.g., instant tickets) with his or her transaction instrument and/or account during a customer session. In this process, the player's account is identified by the system of the present invention (e.g., by scanning a player card associated with the account), and then the player's desired wager purchases (e.g., online or instant tickets) are also scanned or otherwise identified by the system of the present invention. The identified wagers are then associated with the player's account, whether or not the account is associated with a card. The tickets can be paid for via automatic deduction of the funds in the player's account, by cash, or other means. Further, the player can be credited for having purchased the tickets for purposes of receiving benefits, points, rewards, eligibility for other jackpots and related benefits. Once the purchase activity is over, the customer session can then be terminated by the card holder or a POS device operator where appropriate.

The present invention works equally well whether carried out by a clerk using a manned terminal or by the player using a self-service terminal.

### BRIEF DESCRIPTION OF THE DRAWINGS

FIG. 1 is a schematic diagram illustrating one embodiment of a system according to the present invention.

FIGS. 2A and 2B are flow diagrams illustrating process steps in accordance with one embodiment of the present invention.

### DETAILED DESCRIPTION OF EMBODIMENTS OF THE INVENTION

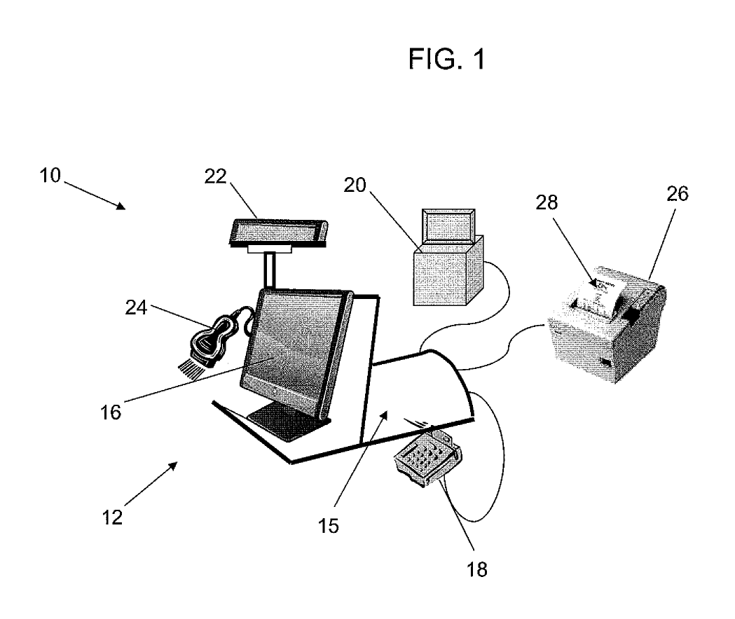

As shown in the embodiment of the present invention depicted in FIG. 1, the system 10 of the present invention incorporates a printer control device (PCD) that issues commands to the printer as discussed hereinafter. The PCD can be a point-of-sale (POS) device 12 that can be a self-service POS device or a POS device that is ordinarily staffed by an operator such as a retail clerk, for example. The POS device 12 can be exclusively for lottery and other gaming-related transactions (e.g., purchase and redemption activities, account credit and debit transactions, transactions for loyalty points, etc.), can be a POS device capable of processing both lottery and non-lottery transactions. In one embodiment of the present invention, the PCD can comprise computer programming such as a computer application operating on a POS device. The PCD can be, or operate on, a local POS terminal such as an in-lane terminal at a retail establishment. Alternatively, the PCD can operate remotely such as in a management office on-site at the retail establishment or an off-site systems operations center, for example, wherein the PCD is in communication with one or more POS devices. In such situations, one or more POS devices in communication with the PCD can operate in a thin client mode as will be understood to those of ordinary skill in the art. It will be appreciated that references to a POS device herein will be understood to refer to any of (1) an instance of a type of PCD, (2) a machine operating a PCD or (3) a machine operating at the instruction of a PCD. It will further be appreciated that account credit and debit transactions, loyalty points transactions and similar transactions that may not be directly related to wagers or games will nonetheless be considered examples of gaming-related transactions for purposes of the present disclosure.

In one embodiment of the present invention, the PCD 12 can include a processor 15 with adequate memory and processing capabilities, a monitor 16, a magnetic stripe scanner 18 for reading transaction cards, for example, a ticket or playslip reader 20, a customer facing display 22 and a barcode scanner 24. A printer 26 is in communication with the PCD 12 for printing and cutting receipts 28. The printer 14 and other peripheral devices such as the scanners 18 and 24, reader 20 and display 22 can communicate with the PCD 12 using known communications technologies, including wireline-based and/or wireless technologies. In one embodiment of the present invention, the system includes multiple POS terminals in communication with the printer or a plurality of printers.

In addition to the input mechanisms described above, the PCD 12 can include a keyboard, with one or more keys representing one or more numbers and/or specific transactions, commands or operations. It will be appreciated that “keys” can mean physical keys as are traditionally found on a physical keyboard, or visual representations of keys, such as touchscreen areas on a monitor with touchscreen input capabilities. In one embodiment of the present invention, the PCD also includes one or more biometric readers for reading biometric information from customers.

In a specific embodiment of the present invention, specific input keys represent specific wagers (e.g., a $5 instant ticket for Game A is represented by one key, a $5 instant ticket for Game B is represented by a second key, a $2 instant ticket for Game C is represented by a third key, etc.) and other specific keys represent non-wager operational commands. For example, one operation key can be used as a command to validate a clerk's identity so the clerk can operate the terminal. Another operation key can be used to signal that a previously entered transaction should be canceled. Another operation key can be the “total”, “send” or “final cut” key that acts to denote the final wager and/or terminate the customer session as otherwise described herein.

In managing customer sessions, the present invention requires some action that initiates a new customer session. Example such actions include receiving an input from a key (e.g., on a POS device) designating a new customer session, receiving an input from a key designating the termination of an existing customer session, and/or reading a magnetic stripe, a barcode or other indicia from a transaction instrument or a portion thereof. A transaction instrument (TI) for purposes of the present disclosure can be a debit card, credit card, stored value card, loyalty card, or player card, for example, and the TI is associated with an account. The TI can be issued to the player at a point of purchase (POP), whether the player is participating in a lottery/gaming activity or not. The player may then use information on the TI, such as a code or identification information, to formally register the TI in the player's name or with player specific information and thereby establish an account. This can be handled at the POP, online after leaving the POP or at a claims center, for example. Player information used in registration can include, for example, name, address, telephone number, e-mail address and other contact information, in addition to other relevant information required for legal or future transactional purposes. The player can fund the account associated with the TI online or in person at the POP, and may subsequently use the TI for general or lottery/gaming purchases, as well as to add credit to the account through cash or credit deposits, or through lottery/gaming winnings.

The account can store account information indicating a player's money balance, loyalty points balance, favorite wagers (e.g., specific numbers for a draw-type game) and player account access verification information (e.g., username and password). The player can change personal and other information associated with the account by, for example, using a computer and accessing a player account management system that stores information and provides secure access to for player account management purposes. In one embodiment of the present invention, the player account management system is accessible online over a network such as the Internet, for example. The player can select or be provided with a username and password or other known authentication means for preventing unauthorized access to the player's account information. The player can optionally remain anonymous but still record player-related information such as favorite wagers by having the account associated with the TI or other identifier that does not reveal the player's identity.

The form factor of the TI can preferably be similar to that of a standard credit, debit or stored value card, and can operate similarly thereto. The cards can implement contact technology such as magnetic stripes, and/or contact-less technology such as scannable barcodes, radio frequency identification (RFID) tags or Bluetooth™, for example. In one embodiment of the present invention, mobile communications devices can be employed as the TI instead of cards, whereby barcodes may be displayed on the visual display of the devices and a communication implementing object other than a magnetic stripe is incorporated for commercial transactions. In a further aspect of the present invention, the TI can be the player themselves or a part of the player, wherein the player's personal biological information (e.g., fingerprint, retina scan, voice or other human biologically unique information) can be recorded and stored with his or her account as part of his or her player information, and then compared with the biometric information measured when the user desires to initiate a transaction using the system of the present invention.

With the system of the present invention, a player can be notified if and when he or she is a winner of one or more wagers as long as the wagers have been properly associated with his or her account. Further, the winnings can be automatically applied to the account associated with the TI. Given the nature and importance of the transactions contemplated by the present invention, it is imperative that accurate customer sessions be established through the system of the present invention. The system of the present invention creates accurate and flawless player sessions to ensure that all wagers and other transactions are accounted for and properly attributed.

The methodology of the present invention accounts for several functions, including deducting appropriate funds from the account associated with the TI when wagers are made, adding appropriate funds to the TI account when wagers are won, adding appropriate loyalty points (where applicable) to the TI account, and ensuring that automatic payments of winnings only go to the TI account associated with the actual winner.

One aspect of the present invention provides an algorithm directing the printer (e.g., lottery POS printer) to avoid cutting a receipt unless either: 1) another receipt is printed; or 2) the assigned input key (e.g., “Total-Send” key) is hit. In this way, an accurate customer session is established.

A system employing the present invention can comprise a printer for printing at least a gaming transaction receipt and a printer control device (PCD) in communication with the printer. A gaming transaction receipt can be, for example, a paper receipt with printing thereon indicating a wager (e.g., numbers in a lottery drawing). A gaming transaction receipt can also include other information such as code information, for example, identifying things such as the location where the wager was made, the account with which the wager is associated, the card used to make the wager, the machine (e.g., PCD) that issued the receipt and/or other specific wager-related information. The gaming transaction receipt can also be, for example, a paper receipt with printing thereon indicating an instant ticket purchased and associated with an account. The gaming transaction receipt need not be associated with an account, and can simply reference a specific wager or group of wagers along with other wager-related information identified above (not including account identification information). Further, the gaming transaction receipt need not be associated with a wager, as it can refer to an account credit or debit transaction or an account loyalty points transaction, for example.

In one embodiment of the present invention, the PCD can read at least a portion of the transaction instrument, receive information pertaining to a gaming-related transaction and associate the gaming-related transaction with an account associated with the transaction instrument. The information pertaining to a gaming-related transaction can be provided by, for example, the PCD reading a gaming playslip, or the PCD receiving input identifying a gaming wager transaction selection (e.g., by the player or a clerk pushing an input key associated with a specific wager). The gaming-related transaction can be a lottery game wager purchase transaction, a lottery game wager redemption transaction, an account credit transaction, and/or an account loyalty points-related transaction, for example.

In the case where a player is making a single wager transaction, the PCD issues a command sequence to the printer to first print the wager-specific information on a paper receipt, and then cut the receipt. By “cutting” it will be understood that the present invention contemplates various styles and techniques for facilitating the removal of a printed receipt from a printer in a neat fashion. For example, cutting the receipt can entail invoking a printer device mechanism that cuts through the paper receipt entirely, or that cuts through the majority of a paper receipt, or that perforates the paper receipt to make it easier for a clerk or a user to tear without tearing the paper away from the perforation line.

In the case where a player is conducting multiple gaming-related transactions, the present invention can operate such that the PCD associates the gaming-related transactions with an account associated with the transaction instrument, and then issues (1) gaming-related transaction information and (2) a command sequence to the printer for each gaming-related transaction. In the instance where a player is making two wagers, for example, the PCD can associate the wager transactions with the account associated with the transaction instrument by communicating with a player account management system (not shown). The communication from the PCD to the account management system provides at least account identification information (based upon the association with the transaction instrument) and wager or gaming-related transaction information. Further, in the same instance were the player is making two wagers, the gaming-related transaction information sent to the printer by the PCD can be specific wager-related information such as that identified above, for example. In this way, the printer has the necessary information to be printed on the receipt.

The command sequence sent to the printer by the PCD depends upon which gaming-related transaction is involved. If it is the first transaction (e.g., wager) of a new customer session, the command “sequence” includes a command to print the wager information (i.e., gaming transaction receipt) associated with the first transaction, and no “cut” command is sent. It will be appreciated that the entire command “sequence” for the first transaction can be a single print command. If a second or subsequent gaming-related transaction is involved for an existing customer session, the command sequence includes an initial command to cut a previously printed receipt associated with the immediately preceding gaming-related transactions, followed by a command to print the gaming-related transaction receipt associated with the second or subsequent of the gaming-related transactions. Again, there is no final “cut” command issued by the PCD to the printer at this time. Upon receiving an indication that no further gaming-related transactions will be associated with the transaction instrument and/or receiving information pertaining to the end of a new or existing customer session (e.g., an input key is hit on the PCD), the PCD then issues a command to the printer to cut the final receipt.

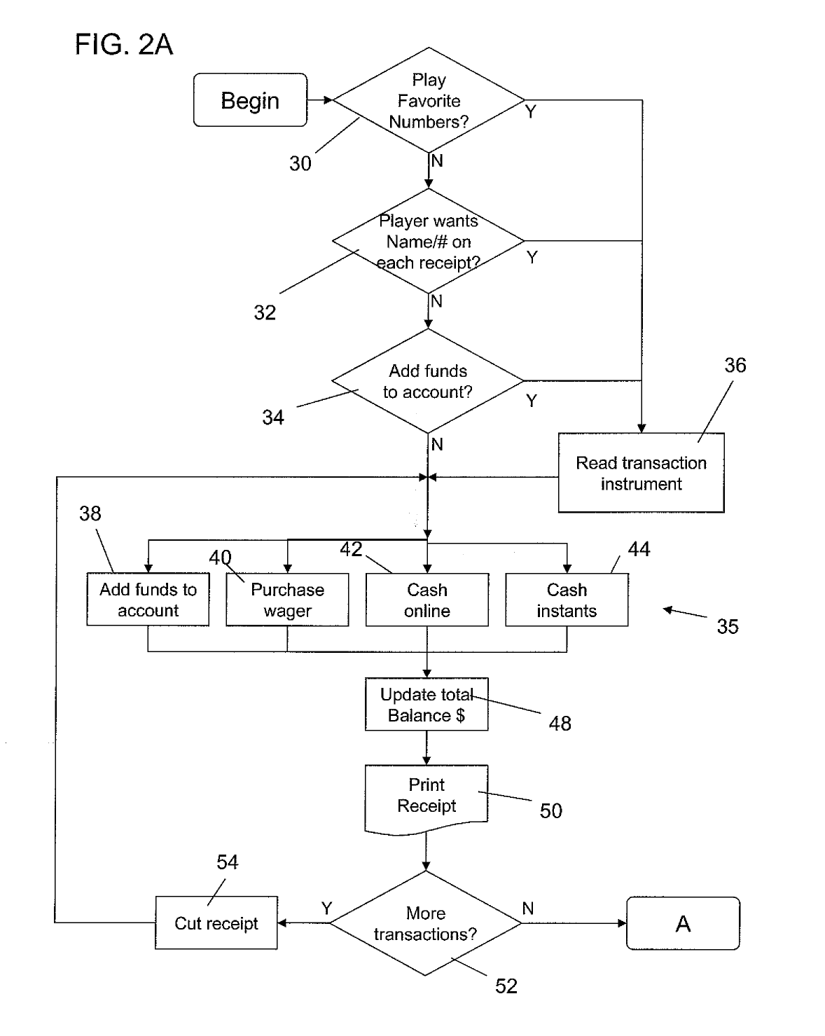

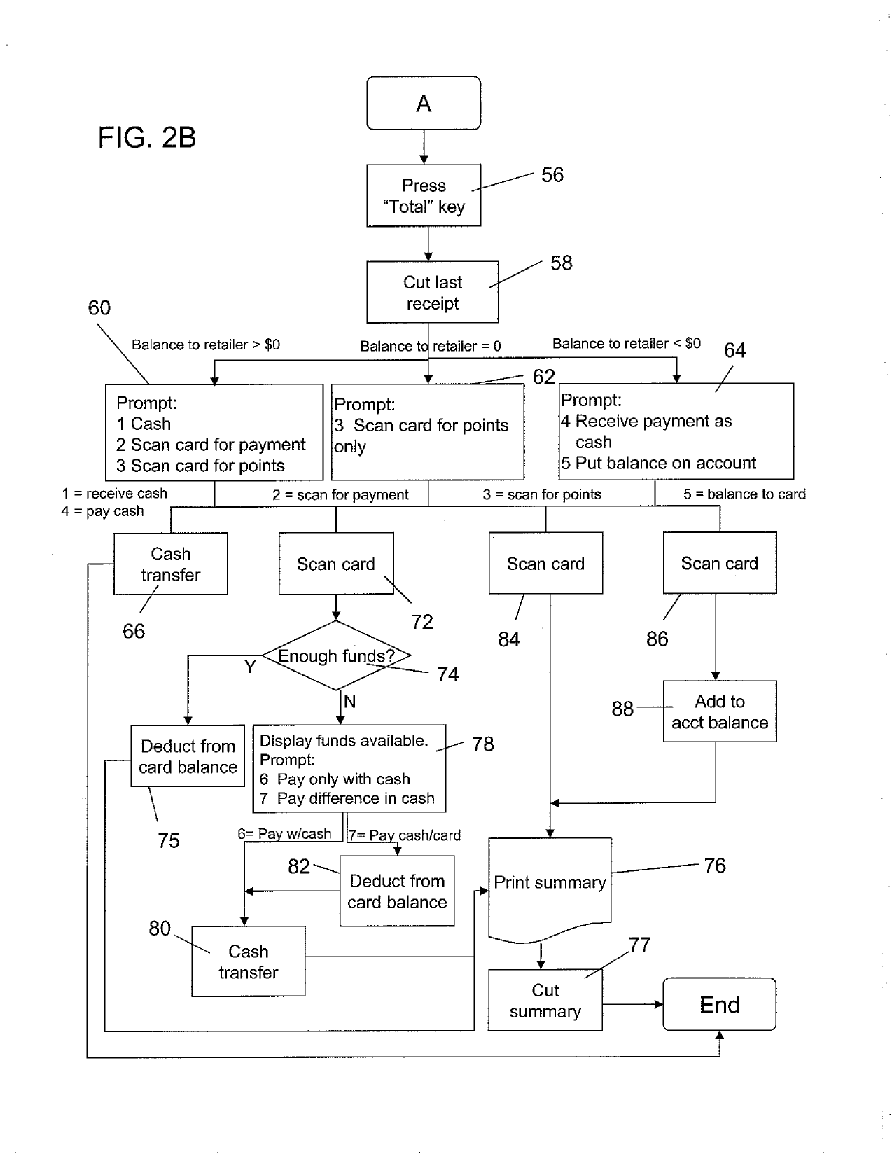

The diagrams of FIGS. 2A and 2B illustrate process flow according to one embodiment of the present invention. As shown in FIG. 2A, a player can be prompted initially as to whether he or she desires to play favorite wager numbers as at 30, have his name or identification number printed on a receipt as at 32, and/or add funds to his or her account as at 34. If the answer to all of these options is “No”, then the process continues the desired transaction among the set of transactions identified generally at 35. If the answer to any of the initial options is “Yes”, then the player's transaction instrument is read as at 36 prior to proceeding to a transaction from the set identified at 35. In reading the transaction instrument at step 36, the PCD can scan a barcode, read a magnetic stripe, read a biometric element, or use other contact and contact-less forms of reading as described elsewhere herein. The PCD can also validate the transaction instrument, request and receive account balance related information (for funds and/or points, for example), and/or request and receive favorite wager information. The validation, request and receive operations take place through communication with the player account management system associated with the present invention.

Whether a transaction instrument is read or not, the set of transactions 35 identified in FIG. 2A become available to the player. The transaction at step 38 is for adding funds to an account, the transaction at step 40 is for purchasing a wager, the transaction at step 42 is for cashing out (i.e., redeeming) an online ticket winner, and the transaction at step 44 is for cashing out an instant ticket winner. The step 38 transaction option (adding funds to an account) would not be presented and/or selected as an option if the player had previously noted that he or she did not wish to conduct such a transaction pursuant to earlier step 34.

Once the transaction has been selected, the PCD can update the total balance of all transactions as at step 48 and sends a command to the printer to print a receipt for the transaction as at step 50. The player is then queried for whether additional transactions are desired as at step 52, and if so, the PCD sends a cut command to the printer as at step 54. Upon the player selecting the next transaction from the set at 35, the total balance of all transactions is again updated as at step 48, and the PCD sends a command to the printer as at step 50 to print a receipt for the just-selected transaction. It will be appreciated that there may be no input key or other mechanism for signaling to the PCD that the player wishes to conduct another transaction. As such, there may be no input mechanism associated with the decision point made at step 52. Instead, the actual selection of the transaction among the set 35 can invoke an input (e.g., selecting/striking an input key) that indicates to the PCD that a cut command as at step 54 is to be issued to the printer. In this way, as long as second and subsequent transactions are selected, the command sequence from the PCD to the printer will be to cut the last printed receipt and then print the receipt for the current transaction. Upon there being no indication of any more transactions at decision step 52, the last transaction remains uncut, and the process proceeds to point A, which continues as shown in FIG. 2B.

It will be appreciated that it is immaterial whether the player's transaction instrument is read at the beginning or end of the process. The present invention contemplates that a player may have selected several wagers prior to having a transaction instrument read by the PCD. Regardless of when the transaction instrument is read, the PCD can associate transaction information with the account associated with the transaction instrument.

As shown in FIG. 2B, once the player indicates that no further transactions are desired, the clerk (or the player in the self-service embodiment) selects the “total” key or an equivalent key as at step 56 that sends a command to the printer to cut the last receipt as at step 58. At this point, the PCD notes the final updated balance of all of the transactions (from step 48 in FIG. 2A) so that appropriate payments can be made. The player can then be prompted for payment transaction processing. If there is a balance owed to the retailer, processing at step 60 takes place. If there is a balance owed to the player, processing at step 64 takes place. If there is no balance owed to either the player or the retailer, then processing at step 62 takes place.

In the instance where step 60 is invoked, the player is prompted (e.g., by the self-service PCD or the clerk operating the PCD) for a method of payment, including a cash payment option and an account payment option. The player can further be provided with an option to add any loyalty points to his or her account for the transactions processed during the customer session. If paying by cash, the player proceeds to pay as at step 66 and that is the end of the process. If paying by account, the player's card can be scanned by as at step 72. Upon the PCD checking the player's account balance through the player account management system to determine if sufficient funds exist at step 74, if there are sufficient funds in the account, the transaction total is deducted from the account balance as at step 75, and then a printed summary of the transactions can be provided as at step 76. The PCD issues a summary print command to the printer in order to provide for the printed summary, which can include a printed account of the player's account money balance, points balance and an identification of the processed transaction(s), for example. The PCD also issues a cut command so that the printed summary is then cut by the printer, as indicated at step 77, at which point the process ends. If the PCD's inquiry into the player's account balance at step 74 reveals that there are insufficient funds, the PCD can display the funds available and query the player for whether the player would like to pay the difference in cash or pay the total in cash, as indicated at step 78. Funds are deducted from the account balance as at step 82 if that option is selected. Cash transfer is made at step 80 either for the full amount if the full cash payment option is selected or for the balance remaining after the deduction in step 82 if the account deduction option is selected. The process then proceeds with the printed summary (step 76) and cut (step 77) as described above.

If points are available and the player wishes to accrue the points to his or her account, his or her card can be scanned as at step 84, and then the printed summary step 76 and cut step 77 can occur as described above. In one embodiment of the present invention, loyalty points can be used to pay for transactions, in which case the card can be scanned as at step 84 in order to deduct the required points, and then the process continues with the printed summary step 76 and cut step 77 as described above. Should any balance of points only partially satisfy the payment obligation, then the player can be provided with the option of using account money funds or cash to pay the remaining amount owed.

In the instance where neither the player nor the retailer owes the other money, the player can elect at step 62 to add points to his or her account. The process then continues through steps 84, 76 and 77 as described above.

In the instance where the retailer owes a payment to the player as at step 64, payment can be provided as cash as at step 66, and the process then ends, or payment can be provided by crediting a player's account, in which case the player's card can be scanned as at step 86, and the appropriate amount credited to the account as at step 88. The print summary 76 and cut 77 steps then proceed as described above.

In one embodiment of the present invention, if the transaction instrument has been read once in connection with a customer session, then it need not be read again in order to process points, credit an account or take any action otherwise affecting the instrument or the associated account. For example, if the player's card is scanned in order to play favorite wagers, and if the player later wishes to pay for all of the transactions using his or her account associated with the card, then the present invention can provide for a key input that represents such a transaction, rather than having to read the card again.

The beginning and ending of a customer session depend upon the implementation of the present invention involved. In the embodiment of the present invention where the player presents a transaction instrument, the customer session can begin upon the reading of the transaction instrument. Separately, the customer session can begin upon the entry of a first gaming-related transaction whether or not a transaction instrument is presented or read. Thus, if a player wishes to purchase a five dollar instant ticket, and the PCD is provided with an input key representing that transaction, then the customer session can begin when the input key representing the transaction is pressed. In this embodiment, the customer session can be for an anonymous customer, whereby the benefit to customer session tracking may be more pertinent to the customers recognized prior to and after the anonymous customer, because such prior and subsequent customers will not have any of the transactions associated with the anonymous customer associated with them.

The customer session can end upon the PCD receiving an indication that no further gaming-related transactions will be associated with the account associated with the transaction instrument. Alternatively, the customer session can end upon appropriate payment processing functions occurring.

In the event that a player has purchased tickets but does not yet have an account or an associated transaction instrument, or did not associate the tickets with his or her account when purchased, the player can subsequently validate any winning tickets and apply the winnings to a previous or a new account using the system of the present invention.

It will be apparent to one skilled in the art that any computer system that includes suitable programming means for operating in accordance with the disclosed methods also falls well within the scope of the present invention. Suitable programming means include any means for directing a computer system to execute the steps of the system and method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. Aspects of the present invention may be embodied in a computer program product, such as a diskette or other recording medium, for use with any suitable data processing system. The present invention can further run on a variety of platforms, including Microsoft Windows™, Linux™, Sun Solaris™, HP/UX™, IBM AIX™ and Java compliant platforms, for example. Appropriate hardware, software and programming for carrying out computer instructions between the PCD, the various peripheral devices and the printer for the present invention are provided.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

1. A system, comprising:
a printer for printing and cutting at least a gaming transaction receipt; and
a printer control device (PCD) in communication with the printer, the PCD including programming for receiving information pertaining to a gaming-related transaction and issuing gaming-related transaction information and a command sequence to the printer for the gaming-related transaction, wherein the command sequence for the gaming-related transaction depends upon whether the gaming-related transaction is the first transaction of a new customer session or a subsequent transaction of an existing customer session, such that for a subsequent transaction of an existing customer session, the command sequence includes an initial command to cut a previously printed receipt followed by a command to print a gaming transaction receipt associated with the gaming-related transaction, with the PCD further including programming for receiving information pertaining to the end of a new or existing customer session and thereupon issuing a cut command to the printer.

2. The system of claim 1 wherein for the first transaction of a new customer session the command sequence includes a command to print a gaming transaction receipt associated with the gaming-related transaction.

3. The system of claim 1 wherein the information received by the PCD pertaining to the end of a new or existing customer session is received via an input key on the PCD.

4. The system of claim 1 wherein the PCD includes programming to prompt a user of the PCD for payment processing upon issuing a cut command and after receiving information pertaining to the end of a new or existing customer session.

5. The system of claim 1 wherein the gaming-related transaction is taken from the group consisting of: lottery game wager purchase transaction, lottery game wager redemption transaction, transaction instrument credit transaction, lottery points related transaction.

6. The system of claim 1 wherein the PCD is capable of reading a transaction instrument and associating the gaming-related transaction with the transaction instrument.

7. The system of claim 6 wherein the PCD is capable of initiating a new customer session upon reading the transaction instrument.

8. A system, comprising:
a printer for printing and cutting at least a gaming transaction receipt; and
a printer control device (PCD) in communication with the printer, the PCD including programming for issuing a cut command to the printer upon receiving a customer session ending instruction, and the PCD further including programming for issuing a cut command to the printer upon: (a) receiving information pertaining to a first gaming-related transaction, (b) providing instructions from the PCD to the printer to print a transaction receipt associated with the first gaming-related transaction information, and (c) receiving information pertaining to a second gaming-related transaction.

9. The system of claim 8 wherein the PCD further includes programming for issuing a print command to the printer after issuing the cut command upon the occurrence of steps (a)-(c).

10. A method, comprising:
providing a printer for printing and cutting at least a gaming transaction receipt;
providing a printer control device (PCD) in communication with the printer;
receiving, by the PCD, information pertaining to a gaming-related transaction;
determining, by the PCD, whether the gaming-related transaction is the first transaction of a new customer session or a subsequent transaction of an existing customer session;
upon the gaming-related transaction being the first transaction of a new customer session, issuing a first-type command sequence from the PCD to the printer;
upon the gaming-related transaction being a subsequent transaction of an existing customer session, issuing a second-type command sequence from the PCD to the printer, with the second-type command sequence including an initial command to cut a previously printed receipt followed by a command to print a new gaming transaction receipt associated with the gaming-related transaction;
receiving, by the PCD, information pertaining to the end of a new or existing customer session; and
issuing a cut command from the PCD to the printer.

11. The method of claim 10 wherein the first-type command sequence includes a command to print a gaming transaction receipt associated with the gaming-related transaction.

12. The method of claim 10 wherein the information received by the PCD pertaining to the end of a new or existing customer session is received via an input key on the PCD.

13. The method of claim 10 including the further step of prompting a user of the PCD for payment processing.

14. The method of claim 10 wherein the gaming-related transaction is taken from the group consisting of: lottery game wager purchase transaction, lottery game wager redemption transaction, transaction instrument credit transaction, lottery points related transaction.

15. The method of claim 10 including the step of reading a transaction instrument and associating the gaming-related transaction with the transaction instrument.

16. The method of claim 15 wherein reading the transaction instrument initiates a new customer session.

17. A method, comprising:
providing a printer for printing and cutting at least a gaming transaction receipt;
providing a printer control device (PCD) in communication with the printer;
providing the PCD with programming for issuing a cut command to the printer upon receiving a customer session ending instruction; and
providing the PCD with programming for issuing a cut command to the printer upon: (a) receiving information pertaining to a first gaming-related transaction, (b) providing instructions from the terminal to the printer to print a transaction receipt associated with the first gaming-related transaction information, and (c) receiving information pertaining to a second gaming-related transaction.

18. The method of claim 17 including the further step of issuing a print command to the printer after issuing the cut command upon the occurrence of steps (a)-(c).
